(19) United States
(12) Patent Application Publication
(10) Pub. No.: US 2004/0072495 A1
(43) Pub. Date: Apr. 15, 2004

(54) Method of manufacturing gas discharge panel

(76) Inventors: Hiroyuki Yonehara, Hirakata-shi (JP); Hideaki Yasui, Hirakata-shi (JP)

Correspondence Address: SNELL & WILMER LLP, 1920 MAIN STREET, SUITE 1200, IRVINE, CA, 92614-7230, US

(21) Appl. No.: 10/466,539

(22) PCT Filed: Jan. 22, 2002
(86) PCT No.: PCT/JP02/00417

(30) Foreign Application Priority Data
Jan. 23, 2001 (JP) 2001-14126

(51) Int. Cl. H01J 9/38

(52) U.S. Cl. 445/59

(57) ABSTRACT

A gas discharge panel manufacturing method that includes a dielectric layer forming process and a protective layer forming process for respectively forming a dielectric layer and a protective layer on a panel, the manufacturing method including a dielectric layer cleaning process for cleaning a surface of the dielectric layer formed on the panel, prior to the protective layer forming process.

### TECHNICAL FIELD

The present invention relates generally to a manufacturing method for gas discharge panels such as plasma display panels, and in particular to surface modification technology for dielectric layers.

### BACKGROUND ART

In recent years, displays having high-definition images, larger screens, flatter panels and so forth have been in demand, leading to the development of various kinds of displays. A representative type of display that is attracting attention is the gas discharge panel, an example of which is the plasma display panel (PDP).

A PDP generally has a structure in which the surface of two thin pieces of panel glass on which a plurality of electrodes and a dielectric film (dielectric layer) are arranged, are made to face each other with a plurality of barrier ribs interposed therebetween, phosphor layers being arranged between the plurality of barrier ribs, and a discharge gas (e.g. an Ne—Xe gas mixture at 53.2 kPa-79.8 kPa) being enclosed between the two pieces of panel glass, which are then sealed airtight. Power is supplied to the plurality of electrodes when the PDP is driven, and discharges generated in the discharge gas are used to generate fluorescent luminescence.

Consequently, a characteristic of PDPs is that, unlike CRTs, depth measurements and weight are not much affected by increases in screen size, and, unlike LCDS, the viewing angle is not limited. Recently, display devices incorporating PDPs having large screens of 60 inches or greater in size have been commercialized.

In the above structure of a PDP, a dielectric layer is formed by applying a paste that includes a dielectric glass component to a panel glass surface on which electrodes known as display electrodes are disposed, and baking the applied paste in an external atmosphere (oxygen atmosphere) to eliminate a resin component. On the dielectric layer of the glass panel facing the phosphor layers is layered a protective layer, made from a magnesium oxide (MgO), a magnesium fluoride (MgF), a mixture of these, or the like, that is for preventing damage caused by discharges. This protective layer is formed, for example, using a sputtering method, an electron beam (EB) method, a vacuum evaporation method, or the like.

However, many problems, such as pinholes and other flaws, arise in relation to the formed protective layer, and these flaws can result in the dispersion of discharge properties of a PDP shown by discharge voltages and the like. Moreover, these flaws may also bring about a marked reduction in the image quality of PDP display devices assembled as finished products.

As such, there is still apparently room for improvements in the manufacture of PDPs having excellent display characteristics.

In view of the above issues, an object of the present invention is to provide a manufacturing method for a gas discharge panel that allows for the manufacture of gas discharge panels having outstanding display characteristics, by excellently forming a protective layer on a dielectric layer surface.

### DISCLOSURE OF THE INVENTION

In order to resolve the above issues, the present invention is a gas discharge panel manufacturing method that includes a dielectric layer forming process and a protective layer forming process for respectively forming a dielectric layer and a protective layer on a panel, the manufacturing method including, prior to the protective layer forming process, a dielectric layer cleaning process for cleaning a surface of the dielectric layer formed on the panel.

Generally, organic (particularly oil mist) and inorganic grime, dust and the like adhere to a surface of the dielectric layer on which the protective layer is to be formed, as a result of static electricity, the manufacturing environment and the like, and sometimes this forms a contamination layer across much of the dielectric layer. As a result of the grime, dust or contamination layers, the protective layer that ought to be formed correctly over the dielectric layer is sometimes not formed in a vicinity of the dielectric layer surface on which grime, dust or a contamination layer has adhered.

The present invention focuses on this area, and because grime, dust or contamination layers adhering to the dielectric layer surface are removed by pre-cleaning the dielectric layer surface, a dielectric layer surface of high purity is maintained. Since the protective layer is, as a result, excellently formed, avoiding pinholes and other flaws, it is possible to realize the manufacture of gas discharge panels having superior display characteristics due to discharge properties being uniform across the entire panel surface.

Here, as a specific method of conducting the dielectric layer cleaning process, it is possible to use a method selected from ultraviolet irradiation in an oxygen atmosphere, plasma irradiation in an oxygen atmosphere, and sputtering in an inert gas atmosphere.

Here, when ultraviolet irradiation is conducted in the dielectric layer cleaning process, the oxygen atmosphere preferably is in a range from atmospheric pressure to 10⁻³ Pa. Moreover, ultraviolet rays having wavelengths in a range from 160 nm to 190 nm preferably are irradiated.

Furthermore, when sputtering is conducted in the dielectric layer cleaning process, a negative voltage preferably is applied to the panel, since active particles are accelerated as a result. These numerical values have been arrived at as a result of the assiduous investigations of the inventors.

Moreover, the manufacturing method preferably includes, after the dielectric layer cleaning process and before the protective layer forming process, a preheating process for preheating the panel on which the dielectric layer is formed, since thermal efficiency is improved as a result.

Furthermore, in the dielectric layer forming process, the dielectric layer may be formed on a panel surface on which an electrode is disposed, and in the dielectric layer cleaning process, in addition to the dielectric layer surface, the cleaning may be conducted with respect to an exposed electrode area of the panel surface. By cleaning the exposed electrode area in this way, it is possible to avoid problems such as short-circuits from occurring due to grime, dust or contamination layers.

Moreover, in the present invention, at least from the dielectric layer cleaning process to the protective layer forming process preferably are conducted in an atmosphere isolated from an external atmosphere. By conducting the processes in a limited airtight atmosphere in this way, the dielectric layer surface can be kept clean, thus making it is possible to shift to an excellent protective layer forming process. Here, as in the following embodiment, a dry gas atmosphere apparatus may be used in the present invention to conduct a series of processes from cleaning a dielectric layer on a panel (front panel) and phosphor baking a second plate (back panel) to sealing and evacuating/baking processes, in an airtight atmosphere isolated from an external atmosphere.

### BRIEF DESCRIPTION OF THE DRAWINGS

FIG. 1 is a main structural diagram of a PDP in a first embodiment;

FIG. 2 shows manufacturing steps for a PDP;

FIG. 3 is a plane cross-section diagram of a dry gas atmosphere apparatus;

FIG. 4 is a lateral cross-section diagram of the dry gas atmosphere apparatus;

FIGS. 5A/5B are partial cross-section diagrams of the dry gas atmosphere apparatus showing variations of a protective layer cleaning chamber; and

FIG. 6 is data showing the effects of heating a panel during plasma processing of a dielectric layer.

### BEST MODE FOR CARRYING OUT THE INVENTION

### 1. FIRST EMBODIMENT

### 1-1. PDP Structure

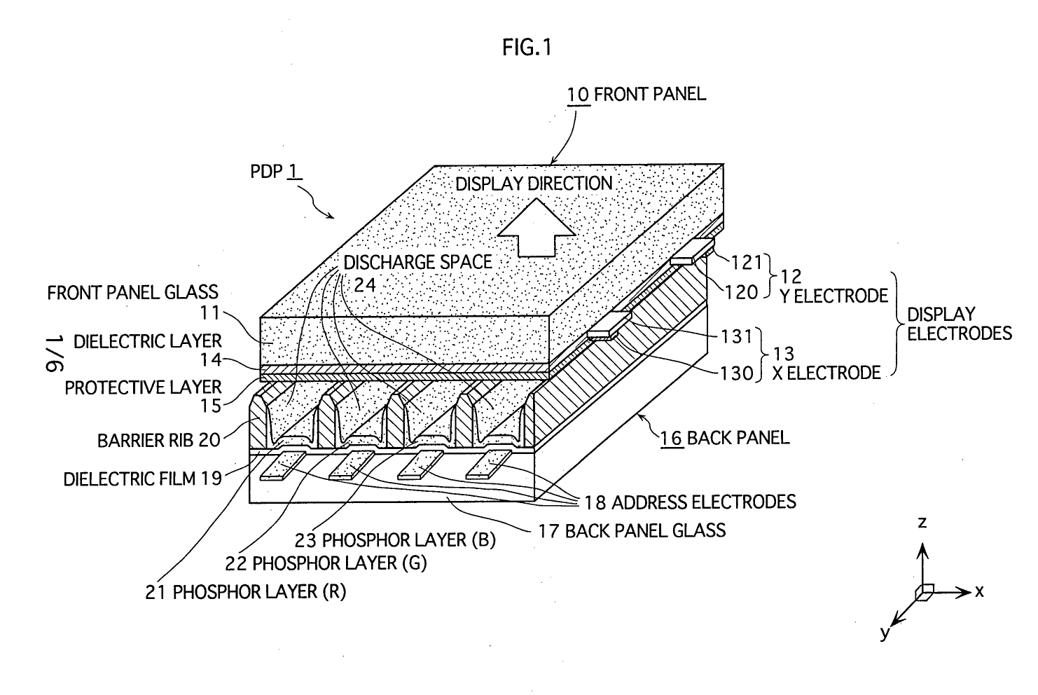

FIG. 1 is a partial cross-sectional perspective diagram showing an alternating-current surface-discharge plasma display panel 1 (hereafter simply “PDP 1”)relating to a first embodiment of the present invention. In FIG. 1, a z direction equates to a thickness direction of PDP 1, and an xy plane equates to a flat surface that is parallel with a panel surface of PDP 1. Although the specifications of PDP 1 here, as an example, correspond to 42-inch class NTSC specifications, the present invention may, of course, be applied to other sizes and specifications.

As shown in FIG. 1, the structure of PDP 1 is broadly divided into a front panel 10 and a back panel 16, which are disposed with main surfaces facing each other.

On a front panel glass 11 forming a substrate of front panel 10 are formed plural pairs of display electrodes 12 and 13 (X electrode 13, Y electrode 12) on one of the main surfaces. Each display electrodes 12 and 13 is formed from band-shaped transparent electrodes 120 and 130 (thickness 0.1 μm, width 150 μm), and bus lines 121 and 131 (thickness 7 μm, width 95 μm) are layered respectively over transparent electrodes 120 and 130.

On front panel glass 11 on which display electrodes 12 and 13 are disposed are sequentially coated a 30 μm thick dielectric layer 14 and a 1.0 μm thick protective layer 15 that cover the entire surface of glass 11.

On a back panel glass 17 forming a substrate of back panel 16 is arranged in a stripe-pattern a plurality of 5 μm thick, 60 μm wide address electrodes 18 on one of the main surfaces, so that the x direction is the lengthwise direction and a regular gap (360 μm) exists between adjacent address electrodes in the y direction, and a 30 μm thick dielectric film 19 is coated over an entire surface of back panel glass 17 so as to encapsulate address electrodes 18. On dielectric film 19 are disposed barrier ribs 20 (height approx. 150 μm, width 40 μm), so as to correspond to the gap between adjacent address electrodes 18, and on the walls of any two adjacent barrier ribs 20 and the surface of dielectric film 19 between the barrier ribs are formed phosphor layers 21 to 23 corresponding respectively to red (R), green (G) and blue (B).

Front panel 10 and back panel 16 having the above structure are arranged facing each other, so that the lengthwise directions of address electrodes 18 and display electrodes 12 and 13 are orthogonal, and the peripheral edges of both panels 11 and 16 are sealed together using glass frit. Between both panels 11 and 16 is enclosed a discharge gas (enclosed gas) made from an inert gas component such as He, Xe, Ne or the like at a predetermined pressure (usually around 53.2 kPa-79.8 kPa).

Between adjacent barrier ribs 20 is a discharge space 24, and areas where a pair of display electrodes 12 and 13 extend across a single address electrode 18 with discharge space 24 sandwiched therebetween corresponds to cells that contribute to image display. Cell pitch is 1080 μm in the x direction and 360 μm in the y direction.

### 1-2 PDP Operation

A panel driving unit (not depicted) is used when driving PDP 1 to apply sustain pulses to each pair of display electrodes 12 and 13, after first applying pulses to address (scan) electrodes 18 and display electrodes 12 in order to conduct a write discharge (address discharge). When a sustain discharge is conducted as a result, a sustain discharge is initiated and image display is conducted.

Here, a characteristic of the present embodiment is the method for manufacturing the PDP. The following description relates the PDP manufacturing method.

### 2. PDP MANUFACTURING METHOD

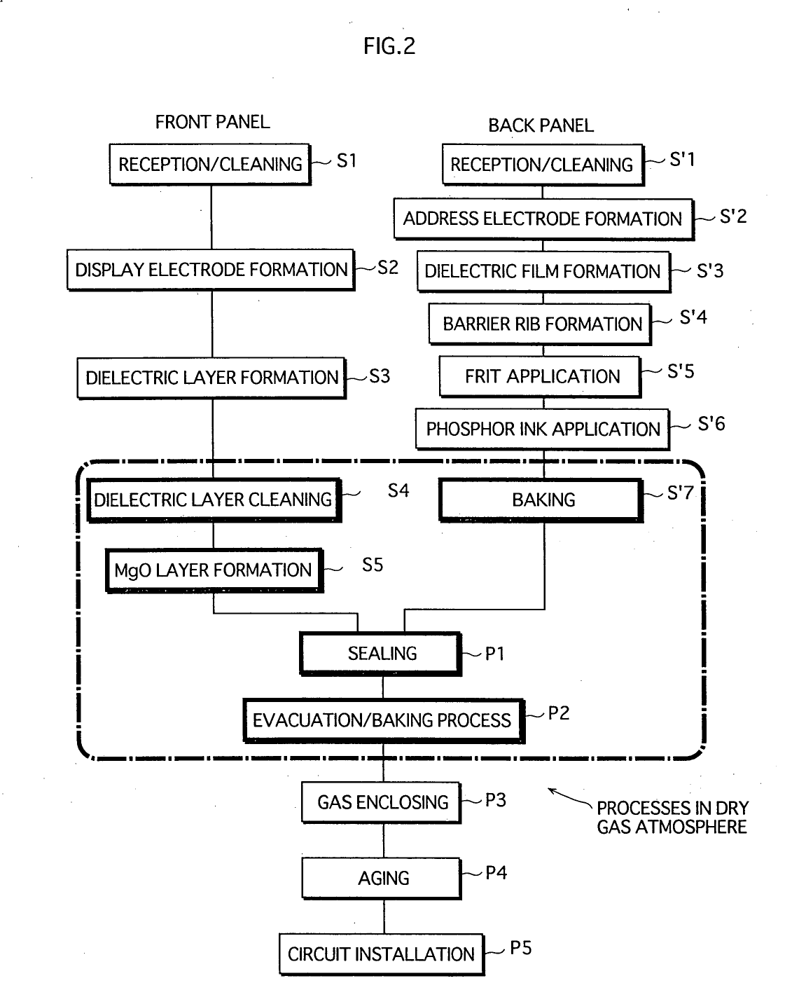

Here, a PDP manufacturing method is described in detail using the PDP manufacturing step diagram shown in FIG. 2. The numbering S, S′, and P used below shows the process steps in the manufacturing step diagram.

### 2-1. Manufacture (S1-S3) of Front Panel (up to Formation of Protective Layer)

First, as front panel glass 11, panel glass made from 2.8 mm thick soda lime glass is prepared, and an acceptance inspection is conducted. This inspection involves checking whether an overall thickness dispersion of the panel glass is ±15 μm, and that there are no cracks, defects, marks, or the like. Panel glass that passes this inspection is washed with solvent or pure water (S1).

Next, on a surface of front panel glass 11 is formed, in a stripe-pattern, 20 μm thick transparent electrodes 120 and 130, using a dielectric material such as ITO (indium tin oxide) or SnO₂. Furthermore, on transparent electrodes 120 and 130 are layered bus electrodes 121 and 131 made from three layers of Ag or Cr/Cu/Cr, thus forming display electrodes 12 and 13 (S2). With respect to these electrode manufacturing methods, known manufacturing methods such as a screen printing method and a photo lithography method can be applied.

Next, on front panel glass 11 on which display electrodes 12 and 13 have been manufactured is coated a lead glass paste over an entire surface, the coated paste is baked at a temperature of 400° C. or more (e.g. profile condition having a peak of 590° C.) in an external atmosphere (oxygen atmosphere) and a resin component included in the paste is eliminated to form 20 to 30 μm thick dielectric layer 14 (S3).

### 2-2. Manufacture (S′1-S′6) of Back Panel (up to Formation of Phosphor Layers)

As back panel glass 17, an acceptance inspection and washing is conducted with respect to a panel glass made from 2.8 mm thick soda lime glass (S′1). These processes S′1 are the same as the processes S1.

Next, on a surface of back panel glass 17 is applied, in a evenly spaced stripe-pattern using a screen-printing method, a dielectric material whose main component is Ag, to form 5 μm thick address electrodes 18 (S′2). Here, to manufacture a 40-inch class high vision television it is necessary to set a gap of around 200 μm or less between any two adjacent address electrodes 18 and barrier ribs 20.

Next, over an entire surface of back panel glass 17 on which address electrodes 18 have been formed is applied a lead glass paste and the applied paste is baked to form 5 to 20 μm thick dielectric film 19 (S′3).

Next, a paste is manufactured using the same lead glass paste as dielectric film 19, and this paste is coated on dielectric film 19 to form a glass layer of approximately 80 μm in thickness. By paring away a section over address electrodes 18 using a sand blast method, 80 μm high, 30 μm wide barrier ribs 20 are patterned between any two neighboring address electrodes 18, and this is baked to form barrier ribs 20 (S′4).

Here, barrier ribs 20 can be formed by printing a plurality of layers of the glass material using a screen-printing method, so as to correspond from the start to a width of barrier ribs 20, and baking this.

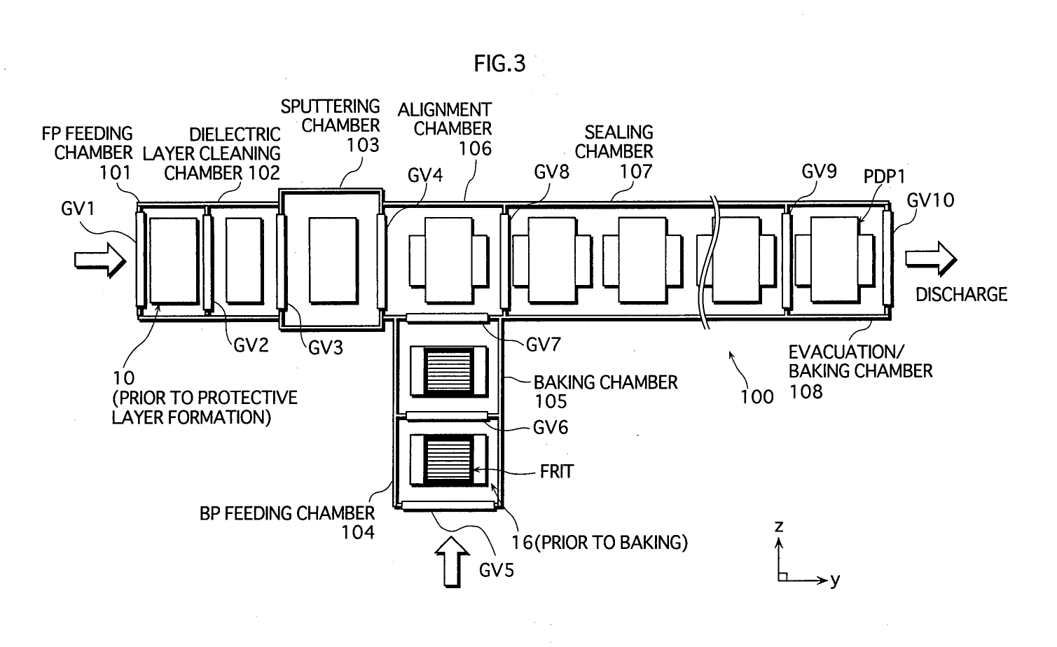

Next, a glass frit used in sealing is applied around a peripheral edge of back panel glass 17 (refer to back panel 16 depicted in FIG. 3, which will be mentioned later) using a screen-printing method (S′5). A thickness of the glass frit at this time is around 20 μm. After application, the glass frit is dried for a fixed period and organic solvent in the glass frit is partially volatilized to reduce a fluidity of the glass frit.

Next, on the wall surface of barrier ribs 20 and on the surface of dielectric layer 14 exposed between adjacent barrier ribs 20 is applied phosphor ink that includes one of red (R) phosphors, green (G) phosphors, and blue (B) phosphors (S′6).

Here, exemplary phosphor materials used in a PDP are listed below. The luminescence center is to the right of the colon.

| | |
|---|---|
| Red Phosphors | (YₓGd₁₋ₓ)BO₃: Eu³⁺ |
| Green Phosphors | Zn₂SiO₄: Mn³⁺ |
| Blue Phosphors | BaMgAl₁₀O₁₇: Eu³⁺ |
| | (or BaMgAl₁₄O₂₃: Eu³⁺) |

The phosphor materials can be, for example, a powder having an average particle size of approximately 3 μm. A screen-printing method or the like is considered appropriate as an application method for phosphor inks. Such a method is considered favorable for those using a method that scans along groves between two adjacent barrier ribs, in order to avoid color mixing of phosphor inks applied in neighboring groves and interference from phosphor inks and glass frit.

### 2-3. Assembly of PDP using a Dry Gas Atmosphere Apparatus (S4, S5, S′7, P1, P2)

Here, as a characteristic of the present embodiment, a dry gas atmosphere apparatus, which is one of the plasma display panel manufacturing apparatuses, is used to conduct, in an airtight atmosphere isolated from an external atmosphere (dry gas atmosphere), processes that include cleaning a front panel dielectric layer, forming a protective layer, baking back panel phosphor layers, and sealing and evacuating/baking both panels.

In the present embodiment, a characteristic is the use of a dry gas atmosphere apparatus 100 to conduct at least dielectric layer cleaning and protective layer forming in an airtight atmosphere isolated from an external atmosphere. At this time, the dielectric layer cleaning is conducted by ultraviolet irradiation in an oxygen atmosphere.

### 2-3-a. Overall Structure of Dry Gas Atmosphere Apparatus

FIG. 3 is an internal structure schematic diagram of dry gas atmosphere apparatus 100 as viewed from above. As shown in FIG. 3, dry gas atmosphere apparatus 100 has a box-shaped cabinet, and is internally formed from various chambers partitioned by shutter-shaped gate valves GV1 to GV10 that slide open/close in a vertical direction (z direction), these chambers including an FP (front panel) feeding chamber 101, a dielectric layer cleaning chamber 102, a sputtering chamber 103, a BP (back panel) feeding chamber 104, a baking chamber 105, an alignment chamber 106, a sealing chamber 107, and an evacuating/baking chamber 108.

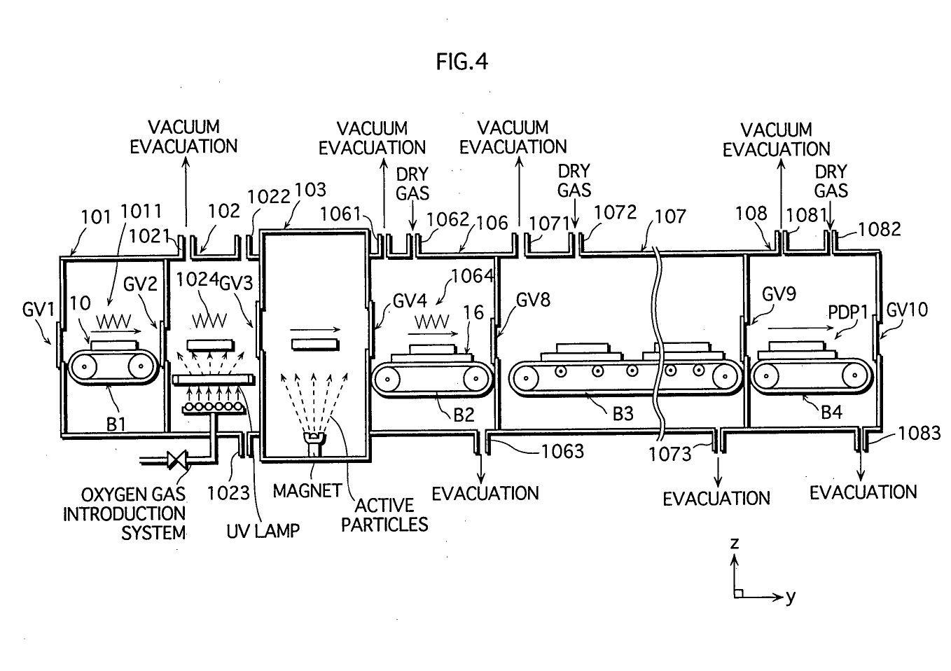

FIG. 4 is a lateral cross-section diagram along the y direction of dry gas atmosphere apparatus 100. Here, for ease of depiction, the interior of baking chamber 105 is not shown.

Belt-driven apparatuses B1 to B4 (and the belt-driven apparatuses of the baking chamber, which are not depicted) are provided in dry gas atmosphere apparatus 100, and panels can be conveyed continuously in the y direction (the belt-driven apparatuses of baking chamber 105 face into the page in FIG. 4) by rotation-driven endless conveyor belts tensioned respectively by driving/follower rollers. Front panel 10 and back panel 16 thus fed from FP feeding chamber 101 and BP feeding chamber 104 are brought together in alignment chamber 106 after passing through sputtering chamber 103, and conveyed through sealing chamber 107 to evacuating/baking chamber 108.

In dielectric layer cleaning chamber 102, baking chamber 105, alignment chamber 106, sealing chamber 107, evacuating/baking chamber 108 and the like are disposed vacuum evacuation ports 1021, 1061, 1071, 1081, . . . , dry gas supply ports 1022, 1062, 1072, 1082, . . . , and dry gas evacuation ports 1023, 1063, 1073, 1083, . . . , for evacuating dry gas circulating in chambers 102, 106 and 107. These can be opened/closed, and it is possible to adjust the gas flow amount and atmospheric pressure within each of the chambers. Vacuum evacuation ports, dry gas supply ports and dry gas evacuation ports are also provided in FP feeding chamber 101, BP feeding chamber 104, baking chamber 105 and the like, although for ease of depiction these are not shown.

Here, what is referred to as “dry gas” indicates, as one example, a dry gas atmosphere of around 1 mPa to 10 mPa inclusive. This dry gas is a gas that is not mixed with an external atmosphere, and is a gas atmosphere in which water vapor partial pressure is reduced, so as to suppress the volume of water absorbed from the atmosphere by the protective layer in the protective layer forming process. In the present embodiment, it is preferable to use a dry gas whose base is, for example, air, since it is necessary for the gas atmosphere in dielectric layer cleaning chamber 102, baking chamber 105 and alignment chamber 106 to include oxygen. This dry gas is obtained, for example, by structuring a dry gas supply pump with an air filter-attached compressor, and eliminating moisture and impurities in the air taken in by the compressor. Although in the present embodiment dry gas having an air base is used, even in FP feeding chamber 101, sputtering chamber 103, BP feeding chamber 104, sealing chamber 107, and evacuating/baking chamber 108, a dry gas that does not include oxygen may be used in these chambers (an inert gas such as Ar gas needs to be used in sputtering chamber 103).

Dry gas supply ports 1022, 1062, 1072, 1082, . . . , are formed so as to be able switch between and supply a type of dry gas (that include oxygen) obtained by drying an Ar gas or air. As described in a later section, the Ar gas is used in the internal cleaning of dry gas atmosphere apparatus 100 early in the driving of the apparatus. A dry gas that includes oxygen is used during normal driving.

An electric heater 1011 is provided in FP feeding chamber 101, and is structured so as to warm (preheat) front panel 10 fed into FP feeding chamber 101 after the dielectric baking to around 120° C. or greater. Moreover, it is possible to degas the inside of the chamber using an evacuation port (not depicted) and create a dry gas atmosphere.

### 2-3-b. Regarding a Structure of the Dielectric Layer Cleaning Chamber

Dielectric layer cleaning chamber 102 is the most characteristic part of the present invention, and is for cleaning a dielectric layer surface of a front panel fed from FP feeding chamber 101 prior to forming a protective layer, using ultraviolet irradiation in an oxygen atmosphere. In dielectric layer cleaning chamber 102, as shown in FIG. 4, is provided an oxygen gas introduction system, evacuation port 1021 for evacuating ozone generated in the chamber, an ultraviolet lamp, heater 1024, and the like. The oxygen gas introduction system maintains the oxygen density in the chamber at an appropriate level. Here, the ultraviolet lamp is, as one example, a lamp that irradiates ultraviolet rays having wavelengths of 160 nm to 190 nm, and partially decomposes the oxygen gas to generate ozone gas. Then, as a result of excited oxygen atoms (oxygen radicals) caused by this ozone gas, contamination layers, accretion and the like of organic (particularly oil mist, etc.) and inorganic matter caused mainly by static electricity and the manufacturing environment of the panel, and adhering to the dielectric layer surface are eliminated. The inside of dielectric layer cleaning chamber 102, at least in the given example (ultraviolet irradiation), needs to be filled with a dry gas that includes oxygen (oxygen atmosphere).

Here, the numerical values given above for the ultraviolet ray wavelengths are particularly suitable for generating exited oxygen atoms. If a low-pressure mercury lamp is used as the ultraviolet lamp, ultraviolet rays having wavelengths of 180 to 190 nm can be obtained. Moreover, if an excimer lamp having Xe enclosed is used, ultraviolet rays having wavelengths of 172 nm can be obtained. Ultraviolet rays having wavelengths in a vicinity of 160 to 180 nm particularly allow for the ready breaking of organic molecular bonds and high cleaning effectiveness. Organic matter decomposed by ultraviolet rays in this way is eliminated though dispersion as CO₂, CO, H₂O and the like.

Furthermore, the ultraviolet ray wavelengths may be numerical values other than those given above (e.g. numerical values in a vicinity of 366 nm, 314 nm, 436 nm).

### 2-3-c. Effects of the Dielectric Layer Cleaning Chamber

Generally, a dielectric layer is formed by applying a paste that includes a dielectric glass component, and baking the applied paste at a high temperature. A protective layer is generally formed on a surface of a dielectric layer formed beforehand on a front panel glass, using a method such as sputtering. Here, in the prior art, due to the effects of static electricity, the manufacturing environment and other factors, the tendency is for grime such as organic (particularly oil mist from machine lubricant) and inorganic matter to readily adhere to the surface of a dielectric layer on which a protective layer is to be formed. This tendency increases considerably with increases in panel glass size, and when the grime is a liquid, a power or the like, a contamination layer may form over large areas of the dielectric layer. Because this kind of grime and contamination layer partially changes the chemical properties of the dielectric layer surface on which they adhere, they cause problems such as pinholes and other flaws when the protective layer is formed, resulting in a protective layer with uneven film thickness, chemical properties, and the like. When the protective layer is not formed appropriately, dispersion of discharge properties occurs when the PDP is driven, and this may lead to noticeable reductions in image quality.

In the present invention in comparison, dry gas atmosphere apparatus 100 shown in FIG. 3 is used to conduct the various manufacturing processes (dielectric layer cleaning, forming of protective layer 15, baking of phosphor layers 21-23, and sealing, evacuating/baking of front panel 10 and back panel 16), including at least the dielectric layer cleaning and protective layer forming processes, consecutively in a dry gas atmosphere isolated from an external atmosphere. In particular, a dry gas atmosphere that includes an oxygen atmosphere is formed within dielectric layer cleaning chamber 102.

In this way, firstly and most importantly, because a dielectric layer is cleaned in dielectric layer cleaning chamber 102 by ultraviolet irradiation in an oxygen atmosphere, the formation of contamination layers and the adherence of grime to the dielectric layer surface can be prevented, and a protective layer can be formed of high purity in comparison to the prior art.

Also secondly, because the gas atmospheres of the processes from the dielectric layer cleaning chamber in dry gas atmosphere apparatus 100 are dry gas atmospheres, the water content of protective layer 15 and phosphor layers 21 to 23 is suppressed, preventing degeneration and allowing display characteristics to be exhibited that represent considerable improvements over the prior art.

### 2-3-d. Regarding the Structure of the Sputtering Chamber and other Chambers

In sputtering chamber 103, which follows dielectric layer cleaning chamber 102, is mounted a known sputtering apparatus, and as shown in FIG. 4, on a front panel surface, on which a dielectric layer has been formed, that is conveyed from the direction of FP feeding chamber 101, are adhered active particles on the surface of the front panel facing a magnet, thus forming a 1 μm thick protective layer made from MgO, MgF or a mixture of these. A vacuum evacuation port, a dry gas supply port and a dry gas evacuation port (not depicted) are also provided in this sputtering chamber 103, and after vacuum evacuating the chamber using the vacuum evacuation port, Ar gas that serves as both a dry gas and a reactive gas is supplied using the dry gas supply port. The inside the chamber is structured so that minute particles generated during the sputtering do not adhere to the panel.

Here, apart from the above gas, a nitrogen gas or a gas whose main component is a mixture of oxygen and neon may be supplied to sputtering chamber 103. Moreover, instead of sputtering chamber 103, a protective layer forming chamber may be provided that is capable of forming a protective layer using a known evaporation method, CVD (chemical vapor deposition) method or the like.

Here, because a panel conveyed to sputtering chamber 103 passes through dielectric layer cleaning chamber 102 according to the present embodiment, a favorable film formation of the protective layer is achieved in sputtering chamber 103, since the dielectric layer surface is markedly cleaner than the prior art. In other words, as a result of the cleaned dielectric layer surface, pinhole flaws, the mixing of grime, and the like, in the protective layer is avoided, thus allowing an appropriate protective layer to be formed.

A known optical alignment apparatus is provided in alignment chamber 106, and alignment of front panel 10 and back panel 16 is performed so as to optically align the position of alignment markers preformed on both panels 10 and 16. An electric heater is further provided in alignment chamber 106, to enable panels conveyed from sputtering chamber 103 and baking chamber 105 to be kept at 120° C. to 150° C. This temperature is set in line with temperatures known to be effective in reducing the adhesion of moisture to the panels. Here, apart from the above panel warming temperatures, setting the temperature to 220° C. or 340° C. is known to be most effective in preventing moisture adhesion (reference: Masao Hashiba et al., “Gas Emission and Absorption Characteristics of Picture Tube Application Materials”, I, II, III, in Vacuum, no. 37 (1994) p.116, no.38 (1995) p.788, no.40 (1997) p.449. Needless to say, the warming temperature should be set depending on the heat resistance of the panels.

The internal walls of baking chamber 105 and sealing chamber 107 are covered with a heat resistant material, and heaters (not depicted) are provided to allow the chambers to be heated.

The various operation timings of belt-driven apparatuses B1 to B4, gate valves GV1 to GV10, vacuum evacuation ports 1021, 1061, 1071, 1081, . . . , dry gas evacuation ports 1063, 1073, 1083, . . . , dry gas supply ports 1022, 1062, 1072, 1082, . . . , vacuum pumps, dry gas supply pumps, alignment apparatuses and the like are controlled by a personal computer (PC) terminal connected to dry gas atmosphere apparatus 100. A detailed content of this control is the various conditions of, for example, the opening/closing of values GV1 to GV10, baking temperatures, sealing temperatures, conveyor belt rotation speeds, dry gas supply speeds, vacuum evacuation timing and chamber internal atmospheric pressures, and can be adjusted by an operator making inputs from the PC terminal. As a result of this control, chambers 101 to 108 are controlled to be filled with a dry gas atmosphere, without coming into contact with an external atmosphere.

Furthermore, discharge-use electrodes (not depicted) are provided in sputtering chamber 103, baking chamber 105, alignment chamber 106 and sealing chamber 107, and after filling chambers 101 to 108 with a discharge gas, discharges can be generated by passing electricity to these electrodes. These discharges suppress the generation of static electricity within the chambers, and subside/decompose impurities.

### 2-3-e. Operations of the Dry Gas Atmosphere Apparatus

According to the above dry gas atmosphere apparatus 100, firstly, when the apparatus 100 is driven, gate valves GV1 to GV10, dry gas evacuation ports 1023, 1063, 1073, 1083, . . . and dry gas supply ports 1022, 1062, 1072, 1082, . . . , are closed, and chambers 101 to 108 are vacuum evacuated by vacuum pumps connected to vacuum evacuation ports 1021, 1061, 1071, 1081, . . . . The decompression value at this time is, for example, 1.33×10⁻¹ mpa. Next, a very small amount (a few sccm to a few dozen sccm) of Ar gas is filled into chambers 101 to 108, and discharges resulting from the Ar gas are conducted within the chambers (approx. 1 minute). The generation of static electricity is suppressed as a result of this operation, in addition to cleaning being conducted and impurities absorbed by the walls within the chambers being eliminated. Here, while it is possible to only conduct one of the vacuum evacuation and the discharges as the cleaning, preferably both the vacuum evacuation and the discharges are conducted in order to favorably form protective layer 15 and phosphor layers 21 to 23.

A predetermined dry gas is supplied to the chambers once the discharges are completed, and since the above processes allow impurities absorbed within the chambers to be eliminated, it is possible to form a high purity gas atmosphere while reducing water vapor partial pressure within the chambers in comparison with conventional gas atmospheres.

Ar gas is supplied to sputtering chamber 103, and a dry gas is supplied to the other chambers 101 and 103 to 108. The quantity of dry gas in the chambers is, for example, a few sccm to a few dozen sccm (standard state calibration). The balance of these quantities of dry gas is preserved by open/close adjustment of dry gas supply ports 1022, 1062, 1072, 1082, . . . , and dry gas evacuation ports 1023, 1063, 1073, 1083,.

Front panel 10, after the dielectric layer has been formed (gradually cooled from approx. 400° C.), is firstly fed to FP feeding chamber 101 by an operator, and kept at 100 to 150° C. by heater 1011. In addition to this, the chamber is degassed and shifted to a dry gas atmosphere.

Next, front panel 10 is, as shown in FIG. 4, fed to dielectric layer cleaning chamber 102 by the rotation driving of belt-driven apparatus B1, and undergoes ultraviolet irradiation having 160 nm to 190 nm wavelengths in an oxygen atmosphere while being kept at 80 to 150° C., surface modification being conducted by oxygen radicals in the ozone gas (exited oxygen atoms). 100 ccm (0.1×10⁻³ m³/min.) of oxygen gas is introduced into dielectric layer cleaning chamber 102 at this time by the oxygen gas introduction system. The surface modification period should be around 15 minutes. As such, this preferably is conducted in an oxygen atmosphere in a range from atmospheric pressure to 10⁻³ Pa. This setting allows contamination layers, grime and the like to be removed from the dielectric layer surface (S4).

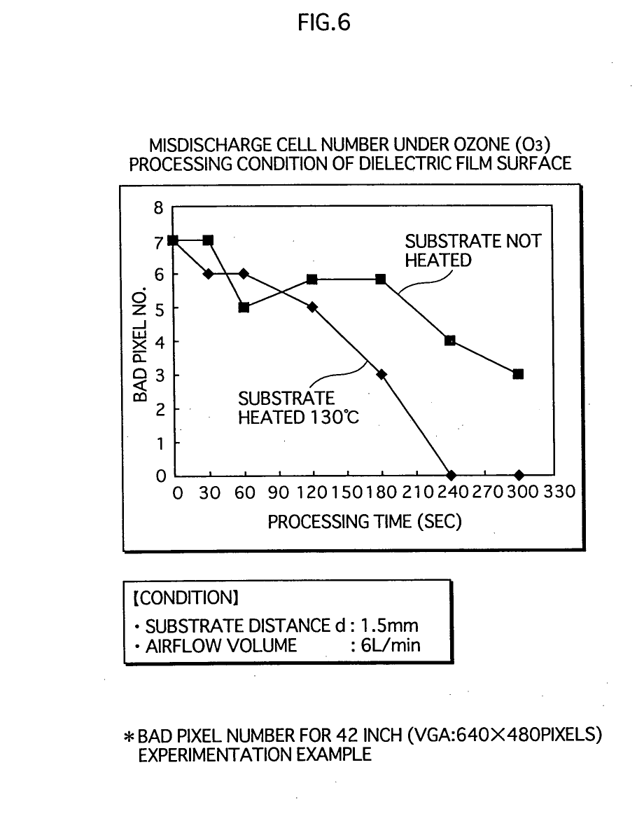

Here, heating the panel when ozone gas is generated allows for improvements in the dielectric layer cleaning rate, and for a reduction in the number of misdischarge cells. FIG. 6 is a graph showing data at this time. Although the FIG. 6 graph shows an example of heating the panel to 130° C., the present invention is not limited to this temperature, and it may be varied appropriately. In terms of the panel heating temperature, it is ascertained from FIG. 6 that heating the panel to 80 to 150° C. allows cleaning rate improvements to be obtained. Moreover, in terms of the time period taken for processing, the time period preferably is 150 (2.5 mins) seconds or more, since this allows the number of misdischarge cells to be kept to around 3 pixels or less.

Furthermore, preferably exposed areas of the display electrodes at edges of the front panel are cleaned at the same time as the above dielectric layer cleaning, since this allows for problems such as short-circuiting to be prevented.

Next, the panel is fed to sputtering chamber 103, and protective layer 15 (here “MgO layer”) is formed (S5). The heating temperature during the sputtering is around 150 to 200° C. After this, front panel 10 is conveyed to alignment chamber 106.

On the other hand, back panel 16 on which phosphor ink and glass frit has been applied (glass frit shown by bold-type outline in FIG. 3) is conveyed from BP feeding chamber 104 to baking chamber 105 and baked (S′7). The heating temperature at this time is set to the phosphor ink baking temperature (approx. 450° C.). Once the baking process is completed, back panel 16 is conveyed to alignment chamber 106 by a belt-driven apparatus (not depicted).

Here, as with protective layer 15, a process may be provided for cleaning the phosphor layers prior to sending the back panel to alignment chamber 106. More specifically, this process may, for example, be ultraviolet irradiation or a method for discharge processing the phosphor layer surfaces. This cleaning process is also preferably conducted in the above gas atmosphere.

In alignment chamber 106, as shown in FIG. 4, alignment operations are performed to correctly position front panel 10 over back panel 16. The panels, which are in a high temperature state immediately following the protective layer formation and phosphor layer formation, are both kept at about the same temperature (120° C.-150° C.) by a heater 1064 provided in alignment chamber 106, aligned without being excessively cooled, and fed to sealing chamber 107 to undergo a sealing process (P1). Consequently, it is possible to quickly heat the panels in the sealing process, and this contributes to manufacturing cost reductions.

The heating temperature during the sealing process is 150° C. to 650° C., and since the panels are kept warm in alignment chamber 106, the heating temperature required for the sealing can be quickly reached. Having passed through gate valve GV9, PDP 1 is carried to evacuating/baking chamber 108 by belt-driven apparatuses B2, B3 and B4, and an evacuating/baking process is conducted (P2).

### 2-3-f. Effects of Dry Gas Atmosphere Apparatus 100

By using the above method employing dry gas atmosphere apparatus 100, it is possible, from the respective formation of protective layer 15 and phosphor layers 21 to 23 until the evacuating/baking process, for front panel 10 and back panel 16 to undergo manufacturing processes in dry gas without being exposed to an external atmosphere. Consequently, the moisture amount absorbed by protective layer 15 from the atmosphere is suppressed in comparison to the prior art, and a high purity protective layer is formed on the clean surface of the dielectric layer.

Here, although phosphors are generally prone to thermal degradation (discoloration) when heated in a state of holding moisture, since evacuation and baking are conducted without the phosphors coming into contact with the open air according to the above method, thermal degradation is avoided. Moreover, because the moisture absorption amount of protective layer 15 is also reduced, the danger of moisture shifting from protective layer 15 to phosphor layer 21 to 23 is largely avoided.

### 2-4. PDP Assembly (P3-P5)

After the sealing process is completed and PDP 1 is removed from evacuating/baking chamber 108 via gate valve GV10, evacuating/baking is conducted at approximately 350° C. or less to create a high vacuum (1.1×10¹ mPa) within discharge space 24. A discharge gas made from a Ne—Xe (5%) composition is enclosed in PDP 1 at a pressure of around 6.7×10⁵ Pa (P3). Here, the P2 processes are also preferably conducted in a reduced-pressure atmosphere or a dry gas having a low water vapor partial pressure, in order to prevent moisture from getting into the PDP as much as possible.

Next, aging is conducted in order to stabilized protective layer 15, phosphor layers 21 to 23, and the drive circuits within PDP1 (P4). A voltage of 250V is applied to the sealed PDP 1 so as to drive the PDP for anywhere from a few hours to a few dozen hours in a black display state. The standard is around 2 hours for a 13-inch screen size and around 8 hours for a 42-inch screen size, although this blank display may be conducted for longer time period ranges than this (e.g. 10-24 hrs inclusive).

After this, the PDP is completed by installing a drive circuit (drive IC), incorporating the housing, cabinet, sound components and the like, and conducting processes to tighten the screws, etc (P5).

### 3. RELATED MATTERS

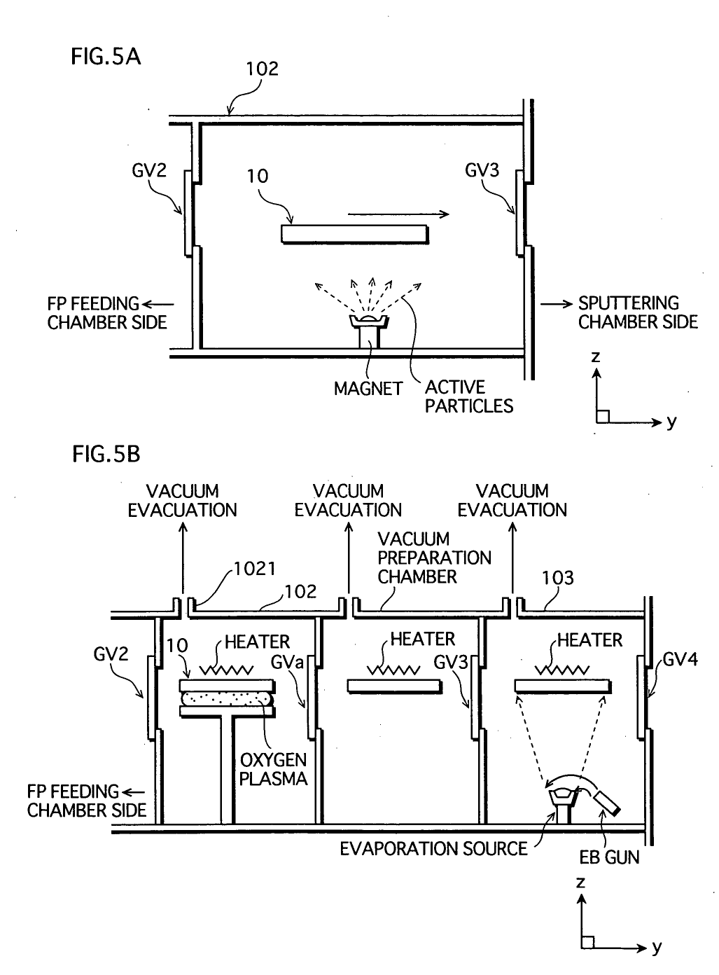

Although in the present embodiment a method of irradiating ultraviolet rays with oxygen present is employed as a means of cleaning a dielectric layer surface, the present invention is not limited to this, and as shown in the FIG. 5A cross-section diagram of the dielectric layer cleaning chamber, the cleaning may be conducted by sputtering active particles placed on a magnet so as to finely grind the dielectric layer surface. Here, a negative bias is preferably applied to the panel at this time, since the active particles are accelerated as a result. In other words, because the use of an inert gas, for example, Ar gas, in the sputtering atmosphere results in Ar being ionized to become Ar⁺ during the sputtering, the cleaning speed (cleanliness) is improved since Ar⁺ is accelerated and reaches the panel surface as a result of the negativity of the panel.

Furthermore, as another means of cleaning a dielectric layer, surface modification may be conducted, as shown in the FIG. 5B partial cross-section diagram of the dry gas atmosphere apparatus, by having oxygen plasma strike the. dielectric layer surface while heating the panel with a heater. Here, after the oxygen plasma processing, it is preferable to store the panel in a vacuum preparation chamber via gate valve GVa, and to preheat the panel with a heater prior to feeding the panel to a protective layer forming chamber 103 (here, formation is by an EB method), since manufacturing efficiency is improved as a result.

Also, trays for holding the panels may be used in dry gas atmosphere apparatus 100, and the trays may be placed on the conveyor belts of belt-driven apparatuses B1 to B4. In this case, when the trays are brought into the apparatus from outside, there is a danger of impurities (oil mist, grime, dust) dispersing within dry gas atmosphere apparatus 100. Because of this, it is preferable to employ external trays for feeding panels to feeding chambers 101 and 104 from the outside air, and internal trays for use within apparatus 100, and to transfer the panels between these trays, since it is then possible to avert impurities attached to the trays in the outside air mixing with the dry gas.

Furthermore, although in the example given in the present embodiment, heater 1011 and heater 1064 are provided respectively in FP feeding chamber 101 and alignment chamber 106, and both front panel 10 and back panel 16 are heated, because back panel 16 attains a sufficient baking heat in baking chamber 105, it is sufficient if at least the front panel on which protective layer 15 is formed is heated.

Furthermore, although a structure of dry gas atmosphere apparatus 100 was shown in which sputtering chamber 103 is followed by alignment chamber 106, a structure is also possible in which a storage chamber for temporarily storing front panel 10 ejected from sputtering chamber 103 immediately after the protective layer formation is provided between sputtering chamber 103 and alignment chamber 106, and in which front panel 10 is conveyed to alignment chamber 106 after being warmed using a heater provided in the storage chamber.

Also, although in the example given in the above embodiment, processes S4, S5, S′7, P1 and P2 are conducted consecutively in a dry gas atmosphere using dry gas atmosphere apparatus 100, the present invention is not limited to this, and, for example, any of processes S4, S5, S′ 7, P1 and P2 may be conducted by an independent apparatus. In this case, however, it is necessary to keep the panel in an airtight atmosphere in which it is not exposed to an external atmosphere, at least from the dielectric layer formation to the protective layer formation.

Furthermore, although in the example given in the above embodiment, a dry gas set to a low water vapor partial pressure is used as an atmosphere isolated from an external atmosphere, the present invention is not limited to this, and the dielectric layer cleaning and protective layer forming may be conducted in an airtight gaseous body that enables at least the dielectric layer surface to be maintained in a clean state.

Moreover, although the example given in the above embodiment related to the cleaning of a dielectric layer surface on which a protective layer is to be formed, the present invention may, in addition to this, involve the surface of a formed protective layer also being cleaned. More specifically, in the case of the example shown in FIG. 4, a protective layer cleaning chamber having the same structure as dielectric layer cleaning chamber 102 is placed between sputtering chamber 103 and alignment chamber 106. In this case, a protective layer cleaning process preferably is conducted in an oxygen atmosphere in a range from 10 Pa to 10⁻³ Pa. By cleaning the protective layer surface in this way, the infiltration of grime and dust within the PDP can be prevented, and the manufacture of high quality PDPs can be realized.

### Industrial Applicability

The present invention can be applied in televisions, particularly high-vision televisions capable of high-definition image reproduction.

1. A gas discharge panel manufacturing method that includes a dielectric layer forming step and a protective layer forming step of respectively forming a dielectric layer and a protective layer on a panel, wherein
the manufacturing method includes, prior to the protective layer forming step, a dielectric layer cleaning step of cleaning a surface of the dielectric layer formed on the panel.

2. The manufacturing method of claim 1, wherein the dielectric layer cleaning step is conducted using a method selected from ultraviolet irradiation in an oxygen atmosphere, plasma irradiation in an oxygen atmosphere, and sputtering in an inert gas atmosphere.

3. The manufacturing method of claim 2, wherein when ultraviolet irradiation is conducted in the dielectric layer cleaning step, the oxygen atmosphere is in a range from atmospheric pressure to 10⁻³ Pa.

4. The manufacturing method of claim 2, wherein when ultraviolet irradiation is conducted in the dielectric layer cleaning step, ultraviolet rays having a wavelength in a range from 160 nm to 190 nm are irradiated.

5. The manufacturing method of claim 2, wherein when sputtering is conducted in the dielectric layer cleaning step, a negative voltage is applied to the panel.

6. The manufacturing method of claim 1 including, after the dielectric layer cleaning step and before the protective layer forming step, a preheating step of preheating the panel on which the dielectric layer is formed.

7. The manufacturing method of claim 3, wherein water vapor having a partial pressure of 1 mPa to 10 mPa is included in the oxygen atmosphere in the dielectric layer cleaning step.

8. The manufacturing method of claim 1, wherein
in the dielectric layer forming step, the dielectric layer is formed on a panel surface on which an electrode is disposed, and
in addition to the dielectric layer surface, the cleaning is conducted with respect to an exposed electrode area of the panel surface.

9. The manufacturing method of claim 1 including, after the protective layer forming step, a protective layer cleaning step of cleaning a surface of the protective layer using ultraviolet irradiation.

10. The manufacturing method of claim 9, wherein the protective layer cleaning step is conducted in an oxygen atmosphere in a range from 10 Pa to 10⁻³ Pa.

11. The manufacturing method of claim 1, wherein at least from the dielectric layer cleaning step to the protective layer forming step are conducted in an atmosphere isolated from an external atmosphere.

12. The manufacturing method of claim 11, wherein water vapor having a partial pressure of 1 mPa to 10 mPa is included in the atmosphere isolated from the external atmosphere.

13. The manufacturing method of claim 11, wherein the dielectric layer cleaning step is conducted using a method selected from ultraviolet irradiation in an oxygen atmosphere, plasma irradiation in an oxygen atmosphere, and sputtering in an inert gas atmosphere.

14. The manufacturing method of claim 13, wherein when ultraviolet irradiation is conducted in the dielectric layer cleaning step, the oxygen atmosphere is in a range from atmospheric pressure to 10⁻³ Pa.

15. The manufacturing method of claim 13, wherein when ultraviolet irradiation is conducted in the dielectric layer cleaning step, ultraviolet rays having a wavelength in a range from 160 nm to 190 nm are irradiated.

16. The manufacturing method of claim 13, wherein when sputtering is conducted in the dielectric layer cleaning step, a negative voltage is applied to the panel.

17. The manufacturing method of claim 14, wherein water vapor having a partial pressure of 1 mPa to 10 mPa is included in the oxygen atmosphere in the dielectric layer cleaning step.

18. The manufacturing method of claim 11 including, after the dielectric layer cleaning step and before the protective layer forming step, a preheating step of preheating the panel on which the dielectric layer is formed.

19. The manufacturing method of claim 11, wherein in the dielectric layer cleaning step, in addition to the dielectric layer surface, the cleaning is conducted with respect to an exposed electrode area of the panel surface.

20. The manufacturing method of claim 11 including, after the protective layer forming step, a protective layer cleaning step of cleaning a surface of the protective layer using ultraviolet irradiation.

21. The manufacturing method of claim 20, wherein the protective layer cleaning step is conducted in an oxygen atmosphere in a range from 10 Pa to 10⁻³ Pa.

22. A gas discharge panel manufacturing method that includes a dielectric layer forming step and a protective layer forming step of respectively forming a dielectric layer and a protective layer on a panel, wherein
the manufacturing method includes, prior to the protective layer forming step, one of a decomposing step and a grinding step of eliminating accretion on a surface of the dielectric layer formed on the panel.

23. The manufacturing method of claim 22, wherein the decomposing step is conducted using a method that is one of ultraviolet irradiation in an oxygen atmosphere and plasma irradiation in an oxygen atmosphere.

24. The manufacturing method of claim 22, wherein the grinding step is conducted using sputtering in an inert gas atmosphere.

25. The manufacturing method of claim 22, wherein at least from one of the decomposing step and the grinding step to the protective layer forming step are conducted in an atmosphere isolated from an external atmosphere.
